(19) United States
(12) Patent Application Publication
(10) Pub. No.: US 2017/0292903 A1
(43) Pub. Date: Oct. 12, 2017

(54) PARTICLE COMPONENT ANALYZING DEVICE, PARTICLE MULTIPLE-ANALYZING DEVICE AND METHOD FOR USING THE PARTICLE COMPONENT ANALYZING DEVICE

(71) Applicant: FUJI ELECTRIC CO., LTD., Kanagawa (JP)

(72) Inventors: Yoshiki HASEGAWA, Hino-city (JP); Naoki TAKEDA, Yokohama-city (JP); Kazuhiro KOIZUMI, Sagamihara-city (JP); Takamasa ASANO, Hino-city (JP)

(21) Appl. No.: 15/475,079

(22) Filed: Mar. 30, 2017

(30) Foreign Application Priority Data
Apr. 6, 2016 (JP) 2016-076913

(51) Int. Cl. G01N 15/02; G01N 1/44; G01N 15/14; G01K 7/22; G01N 15/06

(52) U.S. Cl. CPC G01N 15/0205; G01K 7/22; G01N 15/0625; G01N 15/1425; G01N 1/44; G01N 2015/0681

(57) ABSTRACT

A particle component analyzing device is provided. The particle component analyzing device comprises: a catching body which catches a particle in an aerosol which is subject to measurement, an energy beam irradiating unit which irradiates an energy beam to the particle which is caught by the catching body, and an analyzer which analyzes at least any of a component and an amount of the particle based on a desorbed component of the particle which is desorbed from the catching body by irradiation of the energy beam, wherein the catching body has a temperature measuring unit, the particle component analyzing device further comprising a controlling unit which controls an output of the energy beam irradiating unit based on a temperature of the catching body which is measured by the temperature measuring unit.

The contents of the following Japanese patent application are incorporated herein by reference:

NO. 2016-076913 filed in JP on Apr. 6, 2016.

### BACKGROUND

### 1. Technical Field

The present invention relates to a particle component analyzing device, a particle multiple-analyzing device and a method for using the particle component analyzing device.

Known is a particle component analyzing device which, after catching a particle with a catching body having a mesh portion, generates a desorbed component of the particle by irradiating an energy beam to the particle and analyzes the desorbed component (for example, refer to Patent Document 1).

### 2. Prior Art Documents

[Patent Document] Patent Document 1: WO No. 2011/114587

By irradiating an energy beam to a catching body, a temperature of a catching body increases. Thereby, a particle is desorbed from the catching body. Upon analyzing the particle which is desorbed from the catching body, if the temperature of the catching body is not controlled, because the temperature of the catching body varies, it becomes difficult to keep a measurement condition constant.

### SUMMARY

In a first aspect of the present invention, a particle component analyzing device is provided. The particle component analyzing device may comprise a catching body, an energy beam irradiating unit and an analyzer. The catching body may catch a particle in an aerosol which is subject to measurement. The energy beam irradiating unit may irradiate an energy beam to the particle which is caught by the catching body. The analyzer may analyze at least any of a component and an amount of the particle based on a desorbed component of the particle which is desorbed from the catching body by irradiation of the energy beam. The catching body may have a temperature measuring unit. The particle component analyzing device may further comprise a controlling unit. The controlling unit may control an output of the energy beam irradiating unit based on a temperature of the catching body which is measured by the temperature measuring unit.

The catching body may have a plurality of mesh structures which are stacked in a predetermined direction. Each of the plurality of mesh structures may have a mesh portion and a support flame portion. The support flame portion may be positioned around the mesh portion and support the mesh portion. The temperature measuring unit may be provided in the support flame portion.

The controlling unit may control an output of the energy beam irradiating unit using the temperature measuring unit which is provided on any face of a plurality of mesh structures other than a front surface of a mesh structure which is positioned on the outermost layer to the energy beam among the plurality of mesh structures.

The temperature measuring unit which is included in the catching body may be any of a thermometric resistor and a thermistor.

Each of the plurality of mesh structures may be a processed SOI substrate. The temperature measuring unit may be a thermometric resistor of a thin film which is provided on the SOI substrate.

In a second aspect of the present invention, a particle multiple-analyzing device is provided. The particle multiple-analyzing device may comprise a particle component analyzing device and a particle measuring device. The particle component analyzing device may be the particle component analyzing device according to any of the above. The particle measuring device may measure at least any of the number and the size of a particle based on a light from the particle by irradiating a laser light to the particle of an aerosol which is subject to measurement.

In a third aspect of the present invention, a method for using the particle component analyzing device is provided. The particle component analyzing device may comprise a catching body having a temperature measuring unit, an energy beam irradiating unit, an analyzer and a controlling unit. The particle component analyzing device may analyze at least any of a component and an amount of a particle in an aerosol. The method for using the particle component analyzing device may comprise the steps of: generating a desorbed component of a particle by the energy beam irradiating unit, measuring a temperature of a catching body by the temperature measuring unit, controlling an output of the energy beam irradiating unit by the controlling unit, and analyzing the desorbed component by the analyzer. In the step of generating a desorbed component of a particle, the energy beam irradiating unit may irradiate an energy beam to a particle which is caught by the catching body and is subject to measurement and to generate a desorbed component of the particle which is desorbed from the catching body by irradiation of the energy beam. In the step of controlling an output of the energy beam irradiating unit, the controlling unit may control an output of the energy beam irradiating unit based on the temperature of the catching body which is measured by the temperature measuring unit.

The method for using the particle component analyzing device may further comprise one or more steps of: maintaining, increasing and decreasing the output of the energy beam irradiating unit by the controlling unit. When a temperature which is measured by the temperature measuring unit is equal to a predetermined temperature, the controlling unit may maintain an output of the energy beam irradiating unit. When a temperature which is measured by the temperature measuring unit is lower than a predetermined temperature, the controlling unit may increase an output of the energy beam irradiating unit. When a temperature which is measured by the temperature measuring unit is higher than a predetermined temperature, the controlling unit may decrease an output of the energy beam irradiating unit.

The summary clause does not necessarily describe all necessary features of the embodiments of the present invention. Also, the present invention may also be a sub-combination of the features described above.

### BRIEF DESCRIPTION OF THE DRAWINGS

FIG. 1 shows a particle multiple-analyzing device 300 in a first embodiment.

FIG. 2 shows a particle component analyzing device 100.

FIG. 3 shows a particle measuring device 200.

FIG. 4A shows an exploded view of a plurality of mesh structures 40 configuring a catching body 30.

FIG. 4B shows the state in which a plurality of mesh structures 40 is stacked.

FIG. 5A shows a single mesh structure 40.

FIG. 5B shows a cross-section taken along B-B′ in FIG. 5A.

FIG. 5C shows a cross-section taken along C-C′ in FIG. 5A.

FIG. 6 is a schematic block diagram which describes a process by a temperature calculating unit 92.

FIG. 7 is a flowchart diagram which shows a method for using a particle component analyzing device 100.

FIG. 8 shows a particle multiple-analyzing device 300 in a second embodiment.

### DESCRIPTION OF EXEMPLARY EMBODIMENTS

Hereinafter, the present invention is described through the embodiments of the invention. However, the following embodiments do not limit the invention according to the claims. Also, all the combinations of the features described in the embodiments are not necessarily essential for means provided by aspects of the invention.

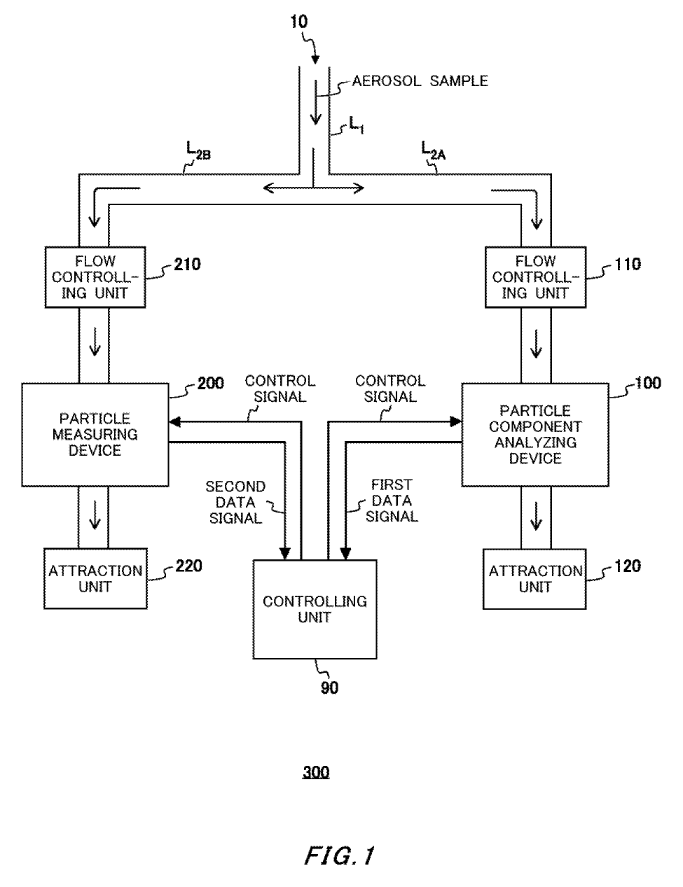

FIG. 1 shows the particle multiple-analyzing device 300 in a first embodiment. The particle multiple-analyzing device 300 of the present example comprises a controlling unit 90, a particle component analyzing device 100, a flow controlling unit 110, an attracting unit 120, a particle measuring device 200, a flow controlling unit 210 and an attracting unit 220. The particle component analyzing device 100 of the present example analyzes a component and an amount per component of a particle which is included in an aerosol sample. Also, the particle measuring device 200 of the present example measures the number and the size of the particle.

In the present example, the aerosol sample is introduced from an inlet 10 to a piping L1. The piping L1 is divided into a piping L_{2A} and a piping L_{2B}. The aerosol sample is introduced to the particle component analyzing device 100 through the piping L_{2A}, and introduced to the particle measuring device 200 through the piping L_{2B}. That is, the aerosol sample is respectively introduced to the particle component analyzing device 100 and the particle measuring device 200 which are connected in parallel. In FIG. 1, a flow of the aerosol sample is shown by an arrow.

The particle multiple-analyzing device 300 of the present example has the flow controlling unit 110 between the inlet 10 and the particle component analyzing device 100, and has the flow controlling unit 210 between the inlet 10 and the particle measuring device 200. The flow controlling unit 110 and the flow controlling unit 210 may respectively regulate a flow rate of the aerosol sample which is introduced to the particle component analyzing device 100 and the particle measuring device 200. The flow rate in the present example may be a volume per unit time [cc/min] under a predetermined temperature and atmospheric pressure.

As a variation, the flow controlling unit 110 may be provided between the particle component analyzing device 100 and the attracting unit 120. Similarly, the flow controlling unit 210 may be provided between the particle measuring device 200 and the attracting unit 220.

The particle multiple-analyzing device 300 of the present example has the attracting unit 120 downstream of the particle component analyzing device 100, and has the attracting unit 220 downstream of the particle measuring device 200 in a flow channel of the aerosol sample. The attracting unit 120 and the attracting unit 220 respectively attract the aerosol sample from the particle component analyzing device 100 and the particle measuring device 200. Thereby, the aerosol sample is discharged outside the particle multiple-analyzing device 300.

The controlling unit 90 of the present example is a computer which is provided outside the particle component analyzing device 100 or the particle measuring device 200. However, in another example, the controlling unit 90 may be provided within the particle component analyzing device 100. Otherwise, instead of this, the controlling unit 90 may be provided within the particle measuring device 200.

The particle component analyzing device 100 and the particle measuring device 200 and the controlling unit 90 of the present example are connected to each other by a signal transmitting means. The controlling unit 90 may control operations of the particle component analyzing device 100 and the particle measuring device 200 by sending a control signal to the particle component analyzing device 100 and the particle measuring device 200. The controlling unit 90 may control operations of the flow controlling units 110 and 210 and the attracting units 120 and 220.

The controlling unit 90 of the present example receives data signals from the particle component analyzing device 100 and the particle measuring device 200. In the present example, a first data signal from the particle component analyzing device 100 includes a first analysis signal which shows at least any of a component and an amount per component of the particle which is included in the aerosol sample, and a temperature information signal which shows a temperature of a catching body 30 described below which is provided in the particle component analyzing device 100. Also, in the present example, a second data signal from the particle measuring device 200 includes a second analysis signal which shows at least any of the number and the size of the particle which is included in the aerosol sample.

In another example, a first data signal which the controlling unit 90 receives from the particle component analyzing device 100 includes at least a temperature information signal. In this case, other signal processing means provided separately from the controlling unit 90 may receive a signal other than the temperature information signal. Also, the controlling unit 90 may be connected to a display unit. The display unit may display at least any of a component and an amount per component of a particle, a temperature of a catching body 30, and the number and the size of the particle.

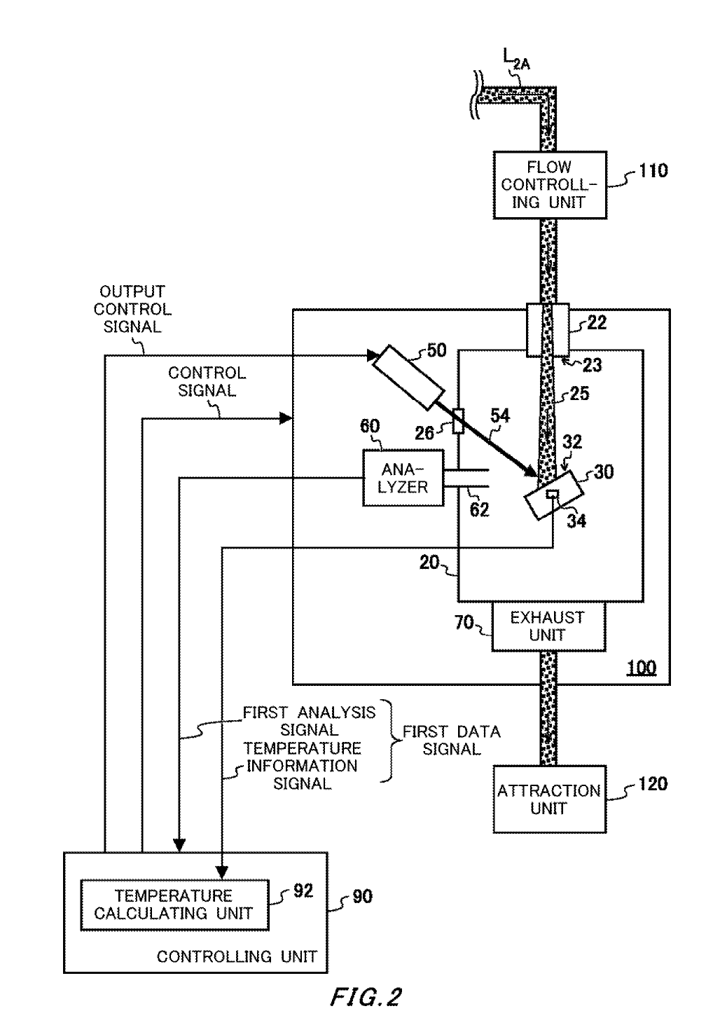

FIG. 2 shows a particle component analyzing device 100. The particle component analyzing device 100 of the present example has a pressure reducing container 20, a particle beam generating unit 22, a catching body 30, an energy beam irradiating unit 50, a recovery cylinder portion 62, a analyzer 60 and an exhaust unit 70. In the particle component analyzing device 100 of the present example, the catching body 30 has a temperature measuring unit 34 which measures a temperature of the catching body 30.

The pressure reducing container 20 is a pressure reducing chamber for providing a pressure-reduced region relative to the outside. The particle beam generating unit 22 generates and injects a particle beam 25 from a particle in an aerosol which is subject to measurement. The particle beam generating unit 22 is, for example, an aerodynamic lens. The particle beam generating unit 22 is provided on a portion of a wall portion of the pressure reducing container 20. The particle beam generating unit 22 penetrates the wall portion of the pressure reducing container 20 while keeping airtightness of the pressure reducing container 20. A particle beam injection outlet 23 is provided on one end of the particle beam generating unit 22.

In the present example, “a particle beam 25 of a particle in an aerosol” refers to a particle beam 25 of a particle that is isolated and condensed into a beam shape from a sample gas in which the particle is floating so that each particle has similar flight and movement characteristics in the sample gas, using aerodynamic characteristics of the particle configured of a solid or a liquid. The sample gas flows into the particle beam generating unit 22 by pressure differential inside and outside the pressure reducing container 20. The particle which passed through the particle beam generating unit 22 passes through the particle beam injection outlet 23 while converging into a beam shape, and is injected as the particle beam 25 of the particle to a reduced pressure atmosphere side.

The catching body 30 catches a particle in the particle beam 25. The catching body 30 has a catching face 32 to which the particle beam 25 is irradiated. The catching body 30 has a mesh-like structure to a portion of a predetermined thickness from the catching face 32. A particle which was not caught by the catching body 30 is discharged outside the particle component analyzing device 100 from the exhaust unit 70.

An injection of the particle beam 25 is stopped after injecting the particle beam 25 for a predetermined time. Then, the energy beam irradiating unit 50 irradiates an energy beam 54 toward the catching body 30. Thereby, the energy beam 54 is irradiated to the particle, generating a desorbed component of the particle. In the present example, “desorb” includes vaporization, sublimation, or elimination reaction. The energy beam 54 passes through a translucent window 26 provided on a portion of the wall portion of the pressure reducing container 20, and reaches the catching body 30 within the pressure reducing container 20. The energy beam 54 is irradiated to a predetermined range of the catching body 30.

The energy beam 54 may be what generates a desorbed component which is appropriate for composition analysis of a particle, and is not particularly limited. The energy beam 54 is, for example, an energy beam 54 which is supplied by a supplier of an infrared laser, a supplier of a visible laser, a supplier of an ultraviolet laser, a supplier of an x-ray, and a supplier of an ion beam.

In the present example, “a desorbed component” is a gas component which is desorbed from the catching body 30 and comes into the state capable of moving to the analyzer 60. The desorbed component may include at least any of CO₂ (carbon dioxide), H₂O (water), NO₂ (nitrogen dioxide) and SO₂ (sulfur dioxide), which are oxides of a constituent components of a particle in an aerosol.

The analyzer 60 analyzes at least any of a component and an amount per component of the particle based on the desorbed component. The analyzer 60 may be a mass spectrometer or a spectrum analyzing device. The analyzer 60 of the present example outputs a first analysis signal depending on an amount or a component of a particle which is ionized and supplied. The analyzer 60 of the present example has one end of the recovery cylinder portion 62 within the pressure reducing container 20. The desorbed component may be introduced into the analyzer 60 through the recovery cylinder portion 62.

The analyzer 60 of the present example has a signal processing unit. The analyzer 60 may calculate based on a measurement signal received as an electrical signal, and derive an amount of the particle. The analyzer 60 may derive a component and an amount per component of the particle. Because a method for deriving the component and the amount per component of the particle from the measurement signal is the same as conventional mass spectrometers, etc., detailed description is omitted.

The controlling unit 90 may control operations of the energy beam irradiating unit 50, the analyzer 60 and the exhaust unit 70. The controlling unit 90 of the present example has a temperature calculating unit 92. The temperature calculating unit 92 is electrically connected to the temperature measuring unit 34 provided in the catching body 30, and calculates a temperature of the catching body 30 based on a temperature information signal from the temperature measuring unit 34. The controlling unit 90 of the present example controls an output of the energy beam irradiating unit 50 by an output control signal depending on the temperature of the catching body 30. As a variation, the particle component analyzing device 100 may have the temperature calculating unit 92.

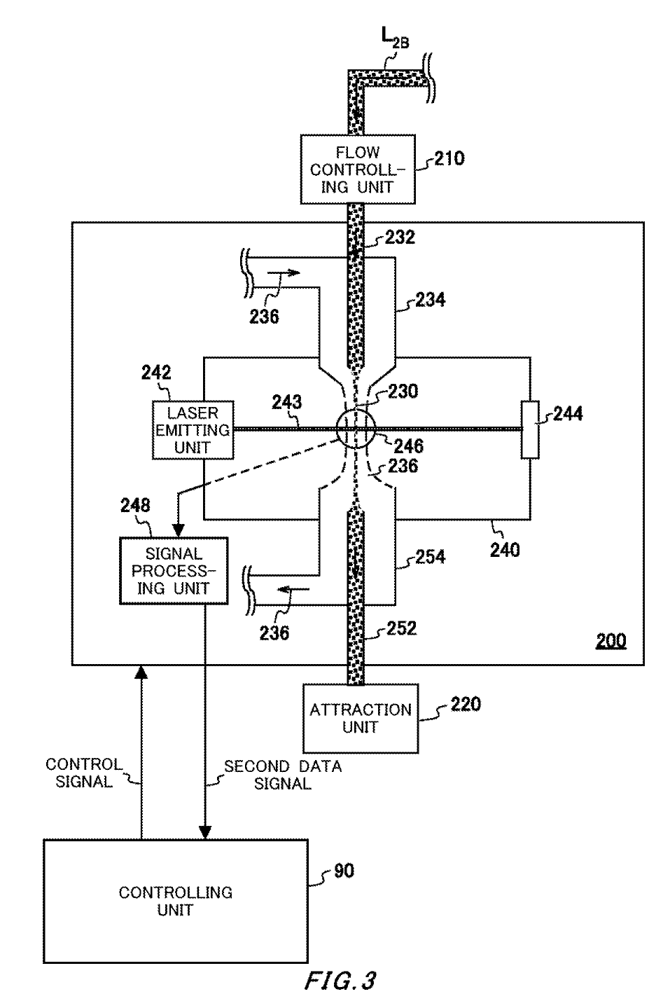

FIG. 3 shows a particle measuring device 200. The particle measuring device 200 of the present example has an aerosol sample injection nozzle 232, a sheath air injection nozzle 234, a detection chamber 240, a signal processing unit 248, an inner pipe portion 252 and an outer pipe portion 254. Also, the detection chamber 240 of the present example has a light receiving unit 246, a laser emitting unit 242 and a beam stopper 244.

The aerosol sample injection nozzle 232 may inject an aerosol sample which is subject to measurement. The sheath air injection nozzle 234 may coat an outer-layer of the aerosol sample with a sheath air 236. Thereby, the aerosol sample whose outer-layer is coated may be injected into the detection chamber 240 as a particle beam 230. A diameter of the particle beam 230 may be about 0.2 [mm].

In the present example, the laser emitting unit 242 is positioned on one end of a longitudinal portion of the detection chamber 240, and the beam stopper 244 is positioned on the other end of the longitudinal portion. The laser emitting unit 242 may irradiate a laser light 243 to the beam stopper 244. An irradiation direction of the laser light 243 and an injecting direction of the particle beam 230 may be approximately orthogonal to each other. A particle in the particle beam 230 may scatter the laser light 243.

The light receiving unit 246 may receive a scattered light of the laser light 243 from the particle beam 230. The light receiving unit 246 may be a photo diode or a photomultiplier. The light receiving unit 246 may convert the scattered light from the particle beam 230 to a pulse-like electrical signal. The light receiving unit 246 may send the converted electrical signal to the signal processing unit 248.

The signal processing unit 248 may calculate the number and the size of the particle from a pulse number and a pulse height value in the pulse-like electrical signal. Thereby, the particle measuring device 200 may measure at least any of the number and the size of the particle based on the scattered light from the particle. The controlling unit 90 may control operations of the laser emitting unit 242, the light receiving unit 246 and the signal processing unit 248 by a control signal.

In the present example, the outer pipe portion 254 is provided with about 5 [mm] to 10 [mm] being separated from the sheath air injection nozzle 234. The inner pipe portion 252 may have a smaller diameter than that of the outer pipe portion 254, and be provided within the outer pipe portion 254. In the present example, the inner pipe portion 252 separates and recovers the aerosol sample, and the outer pipe portion 254 separates and recovers the sheath air 236 from an annular opening. In a flow channel of the sheath air 236, a blast pump may be provided upstream of the sheath air injection nozzle 234, and a attracting pump may be provided downstream of the outer pipe portion 254.

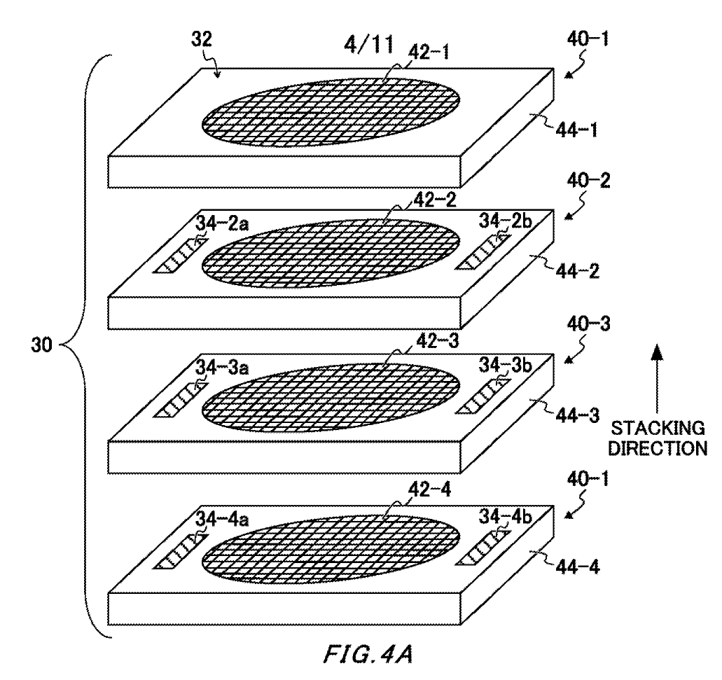

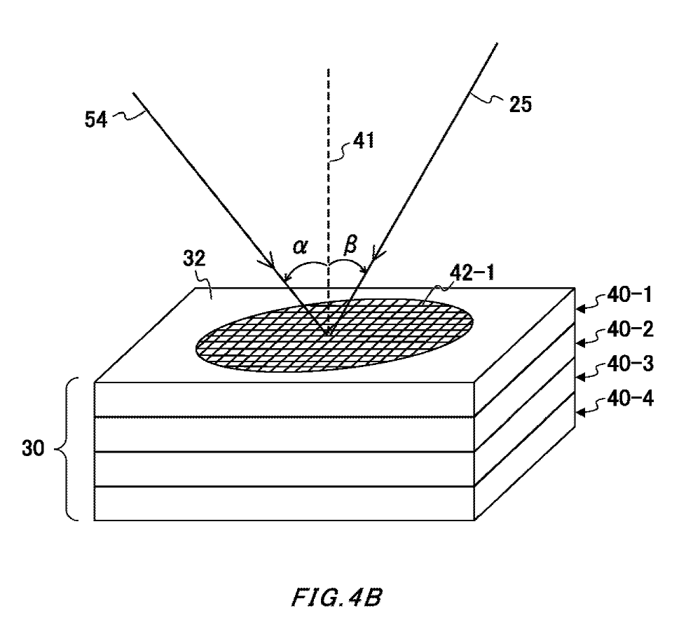

FIG. 4A shows an exploded view of a plurality of mesh structures 40 configuring a catching body 30. As shown in FIG. 4A, the catching body 30 of the present example has four mesh structures 40 which are stacked in a predetermined direction. The catching body 30 may have five or more mesh structures 40, and may have two or three mesh structures 40.

Each of mesh structures 40 has a mesh portion 42 and a support flame portion 44. The support flame portion 44 is positioned around the mesh portion 42 and supports the mesh portion 42. The mesh structure 40 of the present example is a processed SOI substrate. The mesh portion 42 may have a thickness of an active layer of the SOI substrate. The active layer of the SOI substrate refers to a semiconductor layer formed on an insulating film. Also, the support flame portion 44 may have a thickness of the active layer of the SOI substrate and the support substrate. The support substrate of the SOI substrate refers to a semiconductor substrate formed under the insulating film. An active layer which configures the mesh portion 42 and an active layer which configures the support flame portion 44 may be connected.

In the present example, a mesh structure 40 is provided being stacked. Thereby, the mesh portion 42 has a predetermined area porosity when the catching face 32 is seen from a top view. The area porosity is a percentage of an area which an air gap portion occupies to an area of a front surface of the mesh portion 42. The area porosity in the mesh portion 42 may be 80 percent or more, and 99 percent or less. A particle which is incident on the catching body 30 through the catching face 32 is captured by an air gap of the mesh portion 42.

The mesh structure 40 of the present example has a temperature measuring unit 34. The temperature measuring unit 34 may be any of a thermometric resistor and a thermistor. In the present example, a thermometric resistor is used as the temperature measuring unit 34. The temperature measuring unit 34 of the present example is provided in the support flame portion 44. Thereby, a temperature of the catching body 30 can be measured directly. Therefore, the temperature of the catching body 30 can be measured more accurately compared to a technique in which a support metal is provided in the catching body 30 and a temperature of the support metal is measured by a temperature sensor.

The temperature measuring unit 34 may be provided in the support flame portion 44 around the mesh portion 42. In the present example, each of the temperature measuring units 34 is provided at four places near the mesh portion 42. Each of the temperature measuring units 34 may be provided in each of the mesh structures 40. However, in the present example, the temperature measuring unit 34 is not provided on a front surface of a mesh structure 40-1 which is positioned on the outermost layer to the energy beam 54 among the plurality of mesh structures 40. In the present example, among principal surfaces of the catching body 30, a face on the side of the particle beam generating unit 22 is referred to as a “front surface”, and a principal surface on the opposite side is referred to as a “backside surface”. In the present example, the outermost layer is the mesh structure 40-1 which is positioned at the nearest to the energy beam irradiating unit 50 as shown in FIG. 4B.

In the present example, a catching face 32 of the mesh structure 40-1 is a front surface of the mesh structure 40-1. Various substances adhere to the catching face 32. For that reason, there is a case that the temperature measuring unit 34 which is provided on the front surface of the mesh structure 40-1 cannot measure an accurate temperature due to the characteristics change. Therefore, in the present example, the temperature of the catching body 30 is measured using a temperature measuring unit 34 which is provided on any face of a plurality of mesh structures 40 other than the front surface of the mesh structure 40-1 which is positioned at the outermost layer to the energy beam 54. Thereby, the temperature of the catching body 30 can be measured more accurately. The temperature of the catching body 30 may be an average value of temperatures measured by two or more temperature measuring units 34, or a temperature measured by any one of temperature measuring units 34.

FIG. 4B shows the state in which a plurality of mesh structures 40 is stacked. As shown in FIG. 4B, the energy beam 54 and the particle beam 25 of the present example are incident obliquely to a catching face 32. In the present example, a line 41 is a line which is parallel to a stacking direction and perpendicular to the catching face 32. The energy beam 54 forms an angle α (zero degrees<α<ninety degrees) to the line 41, and the particle beam 25 forms an angle β (zero degrees<β<ninety degrees) to the line 41. Angles α and β may be coordinated so as to optimize a catching rate of a particle by the catching body 30 and a desorbing rate of the particle from the catching body 30.

A portion of a particle which is incident on a mesh portion 42 of a mesh structure 40-1 is caught by the mesh portion 42. Also, the other portion of the particle which is incident on the mesh portion 42 of the mesh structure 40-1 is transmitted through the mesh portion 42. However, the particle which is transmitted through the mesh portion 42 of the mesh structure 40-1 is caught at or bounced from a mesh structure 40-2 to a mesh structure 40-4. When bounced, the particle is bounced with a predetermined angle, so it can be caught at a mesh portion 42 of any of the mesh structures 40. Thereby, the catching body 30 of the present example can catch a particle in an aerosol sample efficiently.

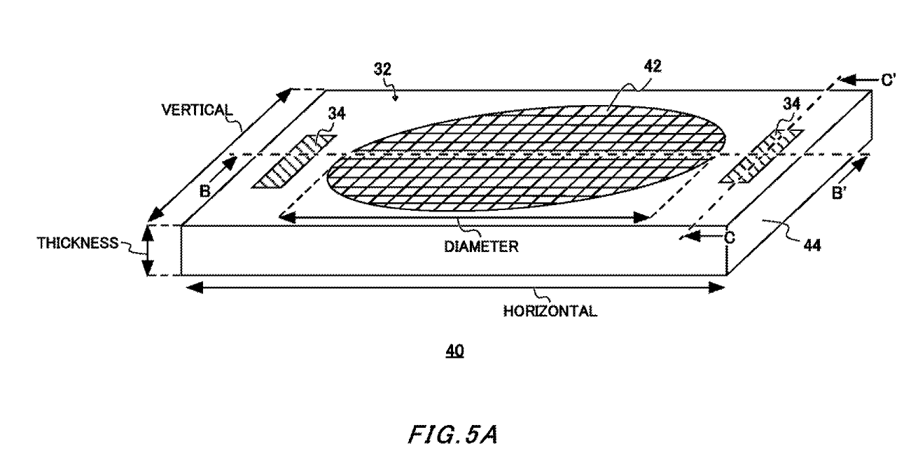

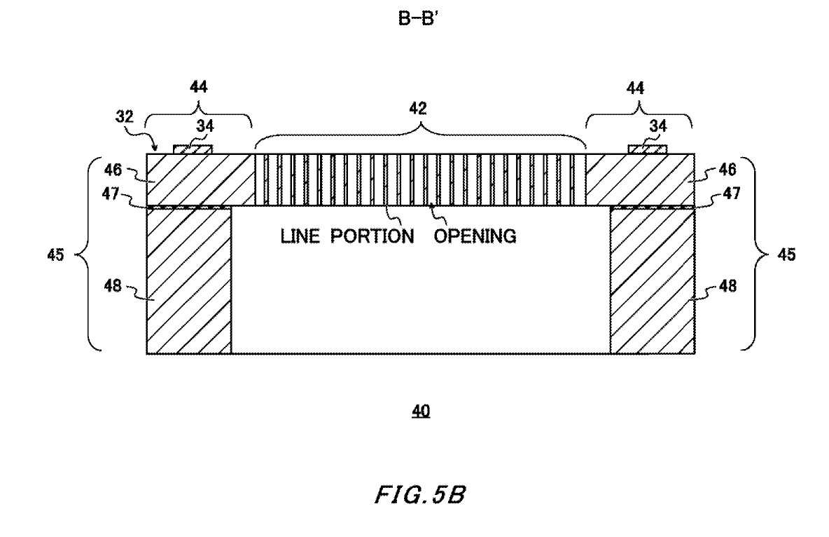

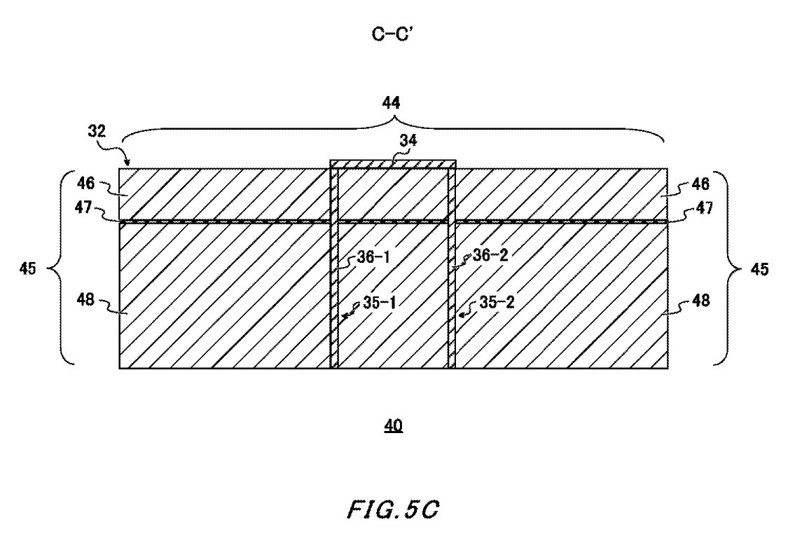

FIG. 5A shows a single mesh structure 40. The mesh structure 40 shown in FIG. 5A corresponds to any of the mesh structures 40-2 to 40-4 other than the mesh structure 40-1 which is positioned at the outermost layer to the energy beam 54.

The mesh portion 42 of the present example is a circular region having a diameter of 3 mm or more, and 8 mm or less. Also, the support flame portion 44 of the present example is a rectangle with a vertical and horizontal length of 5 mm or more, and 10 mm or less, and thickness of 100 μm or more, and 300 μm or less. However, a size and a shape of the mesh portion 42 and the support flame portion 44 is one example, and not limited to the disclosed content of the present example.

The mesh portion 42 has a plurality of line portions which are provided in grid patterns, and a plurality of opening portions which are regulated by the plurality of line portions. The line portion of the present example has a line width of 1 μm or more, and 10 μm or less. Also, the opening of the present example has a square opening which is 10 μm or more, and 100 μm or less on one side.

The temperature measuring unit 34 of the present example is a thin film thermometric resistor which is provided in contact with an active layer of the support flame portion 44. The thin film thermometric resistor may be Pt (platinum). In the present example, because the thin film thermometric resistor is integrally formed on the SOI substrate, the temperature of the catching body 30 can be measured more accurately. Instead of this, the temperature measuring unit 34 may be an NTC thermistor (Negative Temperature Coefficient Thermistor) which is obtained by mixing the oxides such as Ni (nickel), Mn (manganese), Co (cobalt) and Fe (iron) and sintering the mixture.

The controlling unit 90 may control an output of the energy beam irradiating unit 50 based on the temperature which is measured by the temperature measuring unit 34. The controlling unit 90 may increase the output of the energy beam irradiating unit 50 when the temperature of the catching body 30 is lower than a predetermined set temperature T₀, and may decrease the output of the energy beam irradiating unit 50 when the temperature of the catching body 30 is higher than a predetermined set temperature T₀. The predetermined set temperature T₀ of the catching body 30 may be within a range of 250° C. or more and 600° C. or less depending on a component of a measurement object.

The controlling unit 90 may control so that the catching body 30 may be the set temperature T₀ while monitoring temperatures from each mesh structure 40. In one example, a control method may be a PID (Proportional Integral Differential) control. If it is controlled to be the set temperature T₀, other control methods may be of course adopted. In the present example, because the temperature of the catching body 30 can be maintained at the set temperature T₀, the percentage at which the particle becomes a desorbed component and is desorbed from the catching body 30 can be made constant. Thereby, the measurement condition in the particle component analyzing device 100 can be kept constant.

FIG. 5B shows a cross-section taken along B-B′ in FIG. 5A. The mesh portion 42 of the present example is formed in an active layer 46 of an SOI substrate 45. In FIG. 5B, a BOX layer (an embedded oxide layer) 47 is not described, but the BOX layer 47 may be left in the mesh portion 42. The support flame portion 44 of the present example is formed in the active layer 46, the BOX layer 47 and a support substrate 48. The support flame portion 44 may be formed by partially removing the support substrate 48 of a region in which the mesh portion 42 is provided.

A Pt thin film, which is a temperature measuring unit 34 of the present example, may be formed by sputtering on the active layer 46 of the support flame portion 44. The Pt thin film of the present example is provided so as to protrude from the active layer 46. However, in another example, there may be provided a concave portion having a predetermined shape in the active layer 46 and a Pt thin film is provided being embedded in the concave portion. Thereby, the Pt thin film may be so as not to protrude from a catching face 32. In said another example, the catching face 32 after providing the Pt thin film becomes a flat surface, so if mesh structures 40 are stacked, a gap between mesh structures 40 can be eliminated. Thereby, a particle in an aerosol sample can be caught more efficiently.

FIG. 5C shows a cross-section taken along C-C′ in FIG. 5A. In the present example, a pair of via 35 is provided just below a temperature measuring unit 34. A wiring 36 which extends from the temperature measuring unit 34 may extend in the via 35. The temperature measuring unit 34 may include the wiring 36. A plurality of mesh structures 40 may further have a via 35 which passes a wiring 36 of a mesh structure 40 which is positioned in a upper layer. In the present example, “a upper layer” means a mesh structure 40 which is nearer to the outermost layer. For example, a mesh structure 40-2 is positioned in a upper layer than a mesh structure 40-3. Also, in the present example, the opposite to “a upper layer” is expressed as “a lower layer”.

In the present example, the wiring 36 is derived from a bottom surface of a support flame portion 44 of the lowest mesh structure 40 to the outside of the catching body 30, without being exposed to a side surface of the catching body 30. Thereby, the wiring 36 may not be sandwiched between mesh structures 40. For that reason, generating a gap which is equivalent to a thickness of the wiring 36 between mesh structures 40 can be prevented. Therefore, the catching body 30 of the present example can catch a particle in an aerosol sample more efficiently, compared to the case when there is a gap between mesh structures 40.

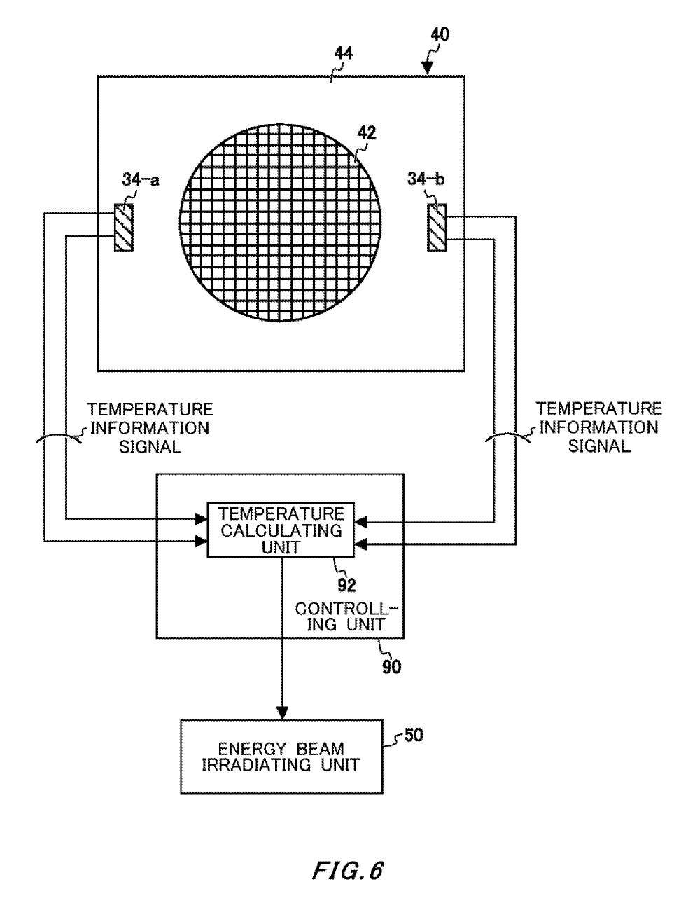

FIG. 6 is a schematic block diagram which describes a process by a temperature calculating unit 92. In the example of FIG. 6, the case when the controlling unit 90 receives a temperature information signal from two temperature measuring units 34-a and 34-b is shown. The controlling unit 90 may respectively receive a temperature information signal from one or three or more temperature measuring units 34.

The temperature calculating unit 92 may calculate a temperature of each of the temperature measuring units 34 based on an electrical resistance value of the temperature measuring unit 34 if the temperature measuring unit 34 is a thermometric resistor or a thermistor. The controlling unit 90 may control an output of an energy beam irradiating unit 50 based on the calculated temperature.

The temperature calculating unit 92 may previously store a table of a value of a temperature depending on an electrical resistance value of the temperature measuring unit 34. The temperature calculating unit 92 may also store a function for converting from an electrical resistance value of the temperature measuring unit 34 to a value of a temperature. Similarly, the temperature calculating unit 92 may previously store a table of a value of a temperature depending on a difference in a thermal electromotive force of the temperature measuring unit 34. The temperature calculating unit 92 may also store a function for converting from a difference in a thermal electromotive force of the temperature measuring unit 34 to a value of a temperature.

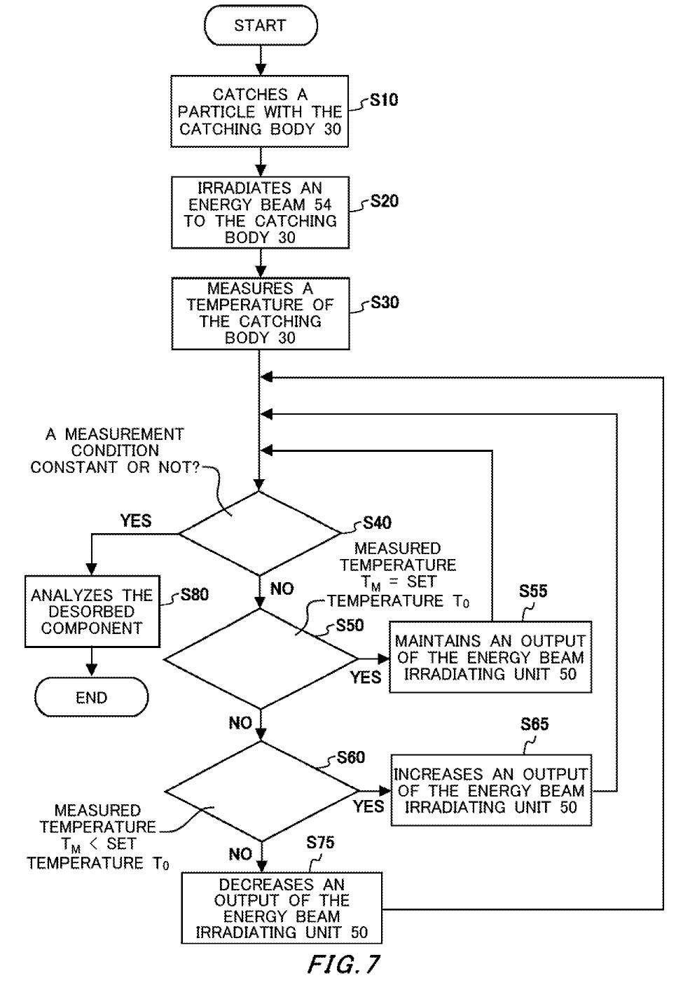

FIG. 7 is a flowchart diagram which shows a method for using a particle component analyzing device 100. In the present example, first, by a particle beam 25 being injected to a catching body 30, a particle in an aerosol sample is caught by the catching body 30 (S10). In one example, a controlling unit 90 controls a flow controlling unit 110 and injects the particle beam 25 to the catching body 30 for a predetermined time.

After S10, an energy beam irradiating unit 50 irradiates an energy beam 54 to the particle. In one example, the controlling unit 90 controls the energy beam irradiating unit 50 and irradiates the energy beam 54 to the catching body 30 for a predetermined time. Thereby, a desorbed component of the particle which is desorbed from the catching body 30 is generated (S20).

After S20, a temperature measuring unit 34 measures a temperature of the catching body 30 (S30). In the present example, the temperature measuring unit 34 sends a temperature information signal to a temperature calculating unit 92 of the controlling unit 90, and the temperature calculating unit 92 calculates a temperature of the catching body 30. After S30, the controlling unit 90 determines whether a measurement condition of the desorbed component became constant or not (S40). In S40, the controlling unit of the present example determines whether a measured temperature T_{M} of the catching body 30 substantially matches a predetermined set temperature T₀ or not during a predetermined time. In the present example, the fact that T_{M} substantially matches T₀ may mean that an absolute value of a difference between T_{M} and T₀ is below or equal to a predetermined temperature difference T_{d} (That is, “|T_{M}−T₀|≦T_{d}”). Also, in the present example, “during a predetermined time” may mean time for a few [sec.] to a few [min.], and the predetermined time may be appropriately decided depending on the desorbed component of the measurement object.

If “|T_{M}−T₀≦T_{d}” is true during the predetermined time (S40:YES), the measurement condition which measures the desorbed component can be considered to have become constant. That is, a generating amount of the desorbed component in a unit time [cc/min] can be considered to have become stable. Therefore, an analyzer 60 analyzes the desorbed component (S80). On the other hand, if it is still “T_{d}<|T_{M}−T₀|” within the predetermined time (S40: NO), the controlling unit 90 controls an output of the energy beam irradiating unit 50 based on T_{M} (S50 to S75).

If T_{M} is equal to T₀ (S50: YES), the controlling unit 90 of the present example maintains an output of the energy beam irradiating unit 50 (S55). That is, it maintains an energy of the energy beam 54. Instead of this, if T_{M} is not equal to T₀ (S50: NO), and T_{M} is lower than T₀ (S60: YES), the controlling unit 90 of the present example increases an output of the energy beam irradiating unit 50 (S65). That is, it increases an energy of the energy beam 54. Also, instead of this, if T_{M} is higher than T₀ (S60: NO), the controlling unit 90 of the present example decreases an output of the energy beam irradiating unit 50 (S75). That is, it decreases the energy of the energy beam 54.

After S50 to S75, the temperature measuring unit 34 measures the temperature of the catching body 30 again (S30). If it is still “T_{d}<|T_{M}−T₀|” within the predetermined time (S40: NO), the controlling unit 90 may further execute one or more steps among S55, S65 and S75, which are controlling the output of the energy beam irradiating unit 50. The controlling unit 90 may repeat controlling the output of the energy beam irradiating unit 50 for a plurality of times until “|T_{M}−T₀≦T_{d}” is true during the predetermined time. Thereby, because a percentage at which the particle becomes the desorbed component and is desorbed from the catching body 30 can be made constant, a measurement condition in the particle component analyzing device 100 can be kept constant.

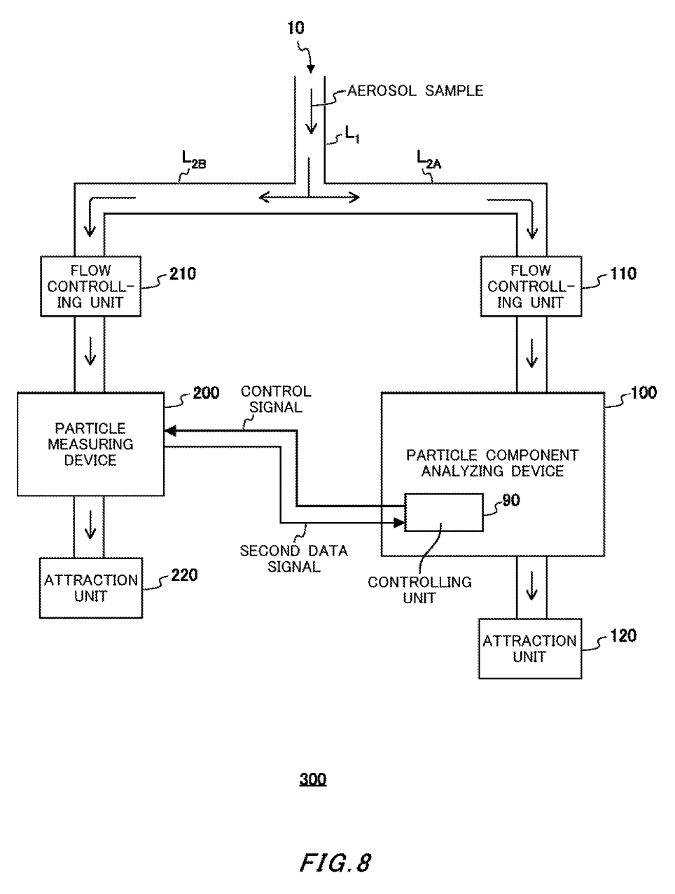

FIG. 8 shows a particle multiple-analyzing device 300 in a second embodiment. The particle component analyzing device 100 of the present example comprises a controlling unit 90. This point is different from the first embodiment. A signal between the particle component analyzing device 100 and the controlling unit 90 is not illustrated, but a function of the controlling unit 90 may be the same as the first embodiment. The controlling unit 90 may be provided within the same casing as the particle component analyzing device 100, or may be provided as a separate computer. In another example, a particle measuring device 200 may comprise the controlling unit 90. In yet another example, the particle component analyzing device 100 may have a controlling unit 90-1, and the particle measuring device 200 may have a separate controlling unit 90-2.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10 . . . inlet, 20 . . . pressure reducing container, 22 . . . particle beam generating unit, 23 . . . particle beam injection outlet, 25 . . . particle beam, 26 . . . translucent window, 30 . . . catching body, 32 . . . catching face, 34 . . . temperature measuring unit, 35 . . . via, 36 . . . wiring, 40 . . . mesh structure, 41 . . . line, 42 . . . mesh portion, 44 . . . support flame portion, 45 . . . SOI substrate, 46 . . . active layer, 47 . . . BOX layer, 48 . . . support substrate, 50 . . . energy beam irradiating unit, 54 . . . energy beam, 60 . . . analyzer, 62 . . . recovery cylinder portion, 70 . . . exhaust unit, 90 . . . controlling unit, 92 . . . temperature calculating unit, 100 . . . particle component analyzing device, 110 . . . flow controlling unit, 120 . . . attracting unit, 200 . . . particle measuring device, 210 . . . flow controlling unit, 220 . . . attracting unit, 230 . . . particle beam, 232 . . . aerosol sample injection nozzle, 234 . . . sheath air injection nozzle, 236 . . . sheath air, 240 . . . detection chamber, 242 . . . laser emitting unit, 243 . . . laser light, 244 . . . beam stopper, 246 . . . light receiving unit, 248 . . . signal processing unit, 252 . . . inner pipe portion, 254 . . . outer pipe portion, 300 . . . particle multiple-analyzing device

What is claimed is:

1. A particle component analyzing device comprising:
a catching body which catches a particle in an aerosol which is subject to measurement,
an energy beam irradiating unit which irradiates an energy beam to the particle which is caught by the catching body, and
an analyzer which analyzes at least any of a component and an amount of the particle based on a desorbed component of the particle which is desorbed from the catching body by irradiation of the energy beam, wherein
the catching body has a temperature measuring unit,
the particle component analyzing device further comprising a controlling unit which controls an output of the energy beam irradiating unit based on a temperature of the catching body which is measured by the temperature measuring unit.

2. The particle component analyzing device according to claim 1, wherein
the catching body has a plurality of mesh structures which are stacked in a predetermined direction,
each of the plurality of mesh structures has
a mesh portion, and
a support flame portion which is positioned around the mesh portion and supports the mesh portion, wherein
the temperature measuring unit is provided in the support flame portion.

3. The particle component analyzing device according to claim 2, wherein the controlling unit controls an output of the energy beam irradiating unit using the temperature measuring unit which is provided on any face of a plurality of mesh structures other than a front surface of a mesh structure which is positioned on the outermost layer to the energy beam among the plurality of mesh structures.

4. The particle component analyzing device according to claim 1, wherein the temperature measuring unit which is included in the catching body is any of a thermometric resistor and a thermistor.

5. The particle component analyzing device according to claim 2, wherein
each of the plurality of mesh structures is a processed SOI substrate,
the temperature measuring unit is a thermometric resistor of a thin film which is provided on the SOI substrate.

6. A particle multiple-analyzing device comprising:
the particle component analyzing device according to claim 1, and
a particle measuring device which measures at least any of a number and a size of the particle based on a light from the particle by irradiating a laser light to the particle of an aerosol which is subject to measurement.

7. A method for using a particle component analyzing device which analyzes at least any of a component and an amount of a particle in an aerosol in the particle component analyzing device comprising a catching body having a temperature measuring unit, an energy beam irradiating unit, an analyzer and a controlling unit, comprising:
by the energy beam irradiating unit, irradiating the energy beam to the particle which is caught by the catching body and is subject to measurement, to generate a desorbed component of the particle which is desorbed from the catching body by irradiation of the energy beam,
by the temperature measuring unit, measuring a temperature of the catching body,
by the controlling unit, controlling an output of the energy beam irradiating unit based on a temperature of the catching body which is measured by the temperature measuring unit, and
by the analyzer, analyzing the desorbed component.

8. The method for using the particle component analyzing device according to claim 7, further comprising one or more of:
by the controlling unit, maintaining an output of the energy beam irradiating unit when a temperature which is measured by the temperature measuring unit is equal to a predetermined temperature,
by the controlling unit, increasing an output of the energy beam irradiating unit when a temperature which is measured by the temperature measuring unit is lower than a predetermined temperature, and
by the controlling unit, decreasing an output of the energy beam irradiating unit when a temperature which is measured by the temperature measuring unit is higher than a predetermined temperature.
